(19) United States
(12) Patent Application Publication
(10) Pub. No.: US 2026/0220616 A1
(43) Pub. Date: Jul. 30, 2026

(54) MAINTENANCE ASSISTANCE SYSTEM AND MAINTENANCE ASSISTANCE METHOD

(71) Applicant: Mitsubishi Electric Corporation, Tokyo (JP)

(72) Inventors: Toshiyuki KURIYAMA, Tokyo (JP); Shun KATO, Tokyo (JP); Hirotoshi YANO, Tokyo (JP)

(21) Appl. No.: 19/143,767

(22) PCT Filed: Jun. 6, 2023
(86) PCT No.: PCT/JP2023/020923

§ 371 Date: Jun. 26, 2025

(51) Int. Cl. G06Q 10/20

(52) U.S. Cl. CPC G06Q 10/20

(57) ABSTRACT

A maintenance assistance system includes: maintenance record information storge circuitry configured to store maintenance record information including data of a plurality of data items and defective component information; importance degree learning circuitry configured to divide the maintenance record information according to a division condition, to learn a relationship between the data item and a defective component in the maintenance record information for each division, and to generate a degree of importance of the data item for each division condition; similar case extraction circuitry configured to divide diagnostic data for diagnosing a diagnostic target device according to the division condition and to extract a similar case similar to the diagnostic data based on a degree of importance of the data item corresponding to the division condition; and defective component estimation circuitry configured to estimate a defective component of the diagnostic target device based on the similar case.

### TECHNICAL FIELD

The present disclosure relates to a maintenance assistance system and a maintenance assistance method.

### BACKGROUND ART

In recent years, a maintenance assistance system has been known that presents candidates for replacement components using accumulated data including past malfunctions and components replaced in response to the malfunctions (for example, see Patent Document 1).

### CITATION LIST

### Patent Document

Patent Document 1: Japanese Unexamined Patent Application, First Publication No. 2020-009068

### SUMMARY OF INVENTION

### Technical Problem

However, in the above-described maintenance assistance system according to the related art, for example, the candidates for the replacement components are selected without considering the difference in failure tendency for each data item such as regionality. Therefore, the problem with the maintenance assistance system according to the related art is that the failure tendency for each data item, such as regionality, is absorbed and the accuracy of failure diagnosis is reduced.

The present disclosure has been made in order to solve the above-described problem, and an object of the present disclosure is to provide a maintenance assistance system and a maintenance assistance method that can improve accuracy of failure diagnosis.

### Solution to Problem

In order to achieve the aforementioned object, according to an aspect of the present disclosure, there is provided a maintenance assistance system including: a maintenance record information storage unit configured to store maintenance record information obtained by diagnosing a diagnostic target device in a past, the maintenance record information including data of a plurality of data items and defective component information; an importance degree learning unit configured to divide the maintenance record information stored in the maintenance record information storage unit according to a division condition predetermined based on the data item, to learn a relationship between the data item and a defective component in the maintenance record information for each division, and to generate a degree of importance of the data item for each division condition; a similar case extraction unit configured to classify diagnostic data for diagnosing the diagnostic target device to be diagnosed according to the division condition and to extract a similar case similar to the diagnostic data from the maintenance record information storage unit based on a degree of importance of the data item corresponding to the classification; and a defective component estimation unit configured to estimate a defective component of the diagnostic target device based on the similar case extracted by the similar case extraction unit.

In addition, according to another aspect of the present disclosure, there is provided a maintenance assistance method for a maintenance assistance system including a maintenance record information storage unit configured to store maintenance record information obtained by diagnosing a diagnostic target device in a past, the maintenance record information including data of a plurality of data items and defective component information. The maintenance assistance method includes: causing an importance degree learning unit to divide the maintenance record information stored in the maintenance record information storage unit according to a division condition predetermined based on the data item, to learn a relationship between the data item and a defective component in the maintenance record information for each division, and to generate a degree of importance of the data item for each division condition; causing a similar case extraction unit to classify diagnostic data for diagnosing the diagnostic target device to be diagnosed according to the division condition and to extract a similar case similar to the diagnostic data from the maintenance record information storage unit based on a degree of importance of the data item corresponding to the classification; and causing a defective component estimation unit to estimate a defective component of the diagnostic target device based on the similar case extracted by the similar case extraction unit.

### Advantageous Effects of Invention

According to the present disclosure, it is possible to improve the accuracy of failure diagnosis.

### BRIEF DESCRIPTION OF DRAWINGS

FIG. 1 A functional block diagram showing an example of a maintenance assistance system according to the present embodiment.

FIG. 2 A diagram showing an example of data in a maintenance record information storage unit in the present embodiment.

FIG. 3 A diagram showing an example of data in a weight storage unit in the present embodiment.

FIG. 4 A diagram showing an example of data in an estimation result storage unit in the present embodiment.

FIG. 5 A diagram showing an example of data in an output information storage unit in the present embodiment.

FIG. 6 A flowchart showing an example of a model learning process of a model learning device according to the present embodiment.

FIG. 7 A flowchart showing an example of a weight learning process of the model learning device according to the present embodiment.

FIG. 8 A flowchart showing an example of a diagnosis process of a diagnostic device according to the present embodiment.

FIG. 9 A diagram showing a hardware configuration of the diagnostic device and the model learning device of the maintenance assistance system according to the present embodiment.

### DESCRIPTION OF EMBODIMENTS

Hereinafter, a maintenance assistance system and a maintenance assistance method according to an embodiment of the present disclosure will be described with reference to the drawings.

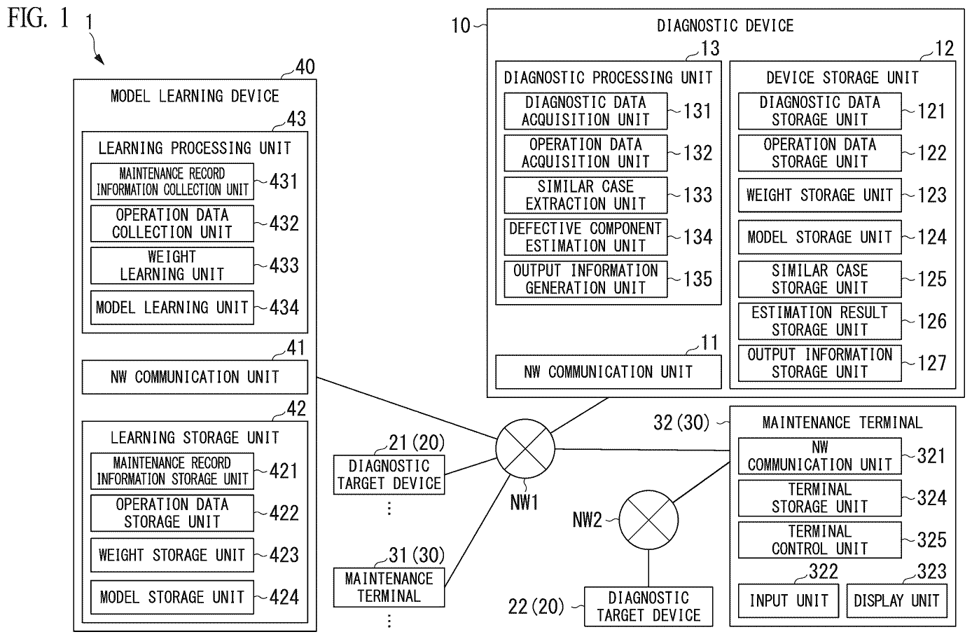

FIG. 1 is a functional block diagram showing an example of a maintenance assistance system 1 according to the present embodiment.

As shown in FIG. 1, the maintenance assistance system 1 according to the present embodiment includes a diagnostic device 10, a plurality of diagnostic target devices 20, a plurality of maintenance terminals 30, and a model learning device 40.

Further, in the present embodiment, in the following description, among the plurality of diagnostic target devices 20, a device that was diagnosed in the past or a device that is in normal operation is referred to as a diagnostic target device 21, and a device that is to be diagnosed at present is referred to as a diagnostic target device 22. In addition, in the following description, in the maintenance assistance system 1, when any diagnostic target device is indicated or when a diagnostic target device is not particularly distinguished, the diagnostic target device is referred to as the diagnostic target device 20.

Furthermore, in the present embodiment, in the following description, among the plurality of maintenance terminals 30, a terminal that has transmitted maintenance record information, which is the past diagnosis result, is referred to as a maintenance terminal 31, and a terminal that is currently performing diagnosis will be described as a maintenance terminal 32. In addition, in the maintenance assistance system 1, when any maintenance terminal is indicated or when a maintenance terminal is not particularly distinguished, the maintenance terminal will be described as the maintenance terminal 30.

Moreover, the diagnostic device 10, the plurality of diagnostic target devices 21, the plurality of maintenance terminals 30 (31, 32), and the model learning device 40 can be connected to a network NW1 and can communicate with each other via the network NW1.

In addition, the diagnostic target device 22 and the maintenance terminal 32 can be connected by a network NW2 and can communicate with each other via the network NW2.

The network NW1 is, for example, a wide area network (WAN). In addition, the network NW2 is, for example, a local area network (LAN) in a building in which the diagnostic target device 22 is installed.

The diagnostic target device 20 (21, 22) is, for example, an appliance such as an air conditioner. The diagnostic target device 20 (21, 22) is a device that is to be subjected to failure diagnosis.

The maintenance terminal 30 (31, 32) is a terminal device for maintaining the diagnostic target device 20 and is, for example, a smartphone, a tablet terminal, a mobile PC (mobile personal computer), or the like. The maintenance terminal 30 (31, 32) is a device for diagnosing the diagnostic target device 20 when a maintenance service provider diagnoses and maintains the diagnostic target device 20 on site or before the maintenance service provider goes to the site.

In addition, the maintenance terminal 32 is a terminal that diagnoses the diagnostic target device 22 to be diagnosed (to be maintained) and includes a network (NW) communication unit 321, an input unit 322, a display unit 323, a terminal storage unit 324, and a terminal control unit 325.

The NW communication unit 321 is, for example, a functional unit that is implemented by a communication device such as a network adapter. The NW communication unit 321 is connected to the network NW2 and can communicate with the diagnostic target device 22. In addition, the NW communication unit 321 is connected to the network NW1 and can communicate with, for example, the diagnostic device 10.

The input unit 322 is an input device such as a keyboard, a touch screen, and a button. The input unit 322 receives various types of input information in response to an operation of a user (maintenance service provider). For example, the input unit 322 is used by the maintenance service provider to input diagnostic data. The diagnostic data includes, for example, the model name, years of installation, installation area, malfunction symptom, and the like of the diagnostic target device 22.

The display unit 323 is, for example, a display device such as a liquid crystal display. The display unit 323 displays, for example, an input screen for inputting the diagnostic data and output information received from the diagnostic device 10 which will be described below. Here, the output information is, for example, a diagnosis result for the diagnostic data and is a candidate for a defective component or the like.

The terminal storage unit 324 stores various types of information used by the maintenance terminal 32. The terminal storage unit 324 stores, for example, input information from the input unit 322, information displayed on the display unit 323, information transmitted to and received from the diagnostic device 10, and the like.

The terminal control unit 325 is, for example, a functional unit implemented by causing a processor including a central processing unit (CPU) to execute a program. The terminal control unit 325 transmits, for example, the diagnostic data received through the input unit 322 to the diagnostic device 10 via the network NW1. In addition, for example, the terminal control unit 325 transmits operation data acquired from the diagnostic target device 22 via the network NW2 to the diagnostic device 10 via the network NW1. Further, the terminal control unit 325 displays the output information received from the diagnostic device 10 via the network NW1 on the display unit 323.

Furthermore, the above-described operation data includes detection data of various sensors (not shown) included in the diagnostic target device 22, error code information, and the like.

The model learning device 40 is, for example, a server device that can be connected to the network NW1. The model learning device 40 executes a weight learning process and a process of learning a defective component detection model. In addition, the model learning device 40 includes an NW communication unit 41, a learning storage unit 42, and a learning processing unit 43.

The NW communication unit 41 is a functional unit that is implemented by a communication device such as a network adapter. The NW communication unit 41 is connected to the network NW1 and can communicate with the diagnostic target device 21, the maintenance terminal 31, and the diagnostic device 10.

The learning storage unit 42 is, for example, a storage device, such as a RAM, a flash memory, or a hard disk drive (HDD), and stores various types of information used by the model learning device 40. The learning storage unit 42 includes a maintenance record information storage unit 421, an operation data storage unit 422, a weight storage unit 423, and a model storage unit 424.

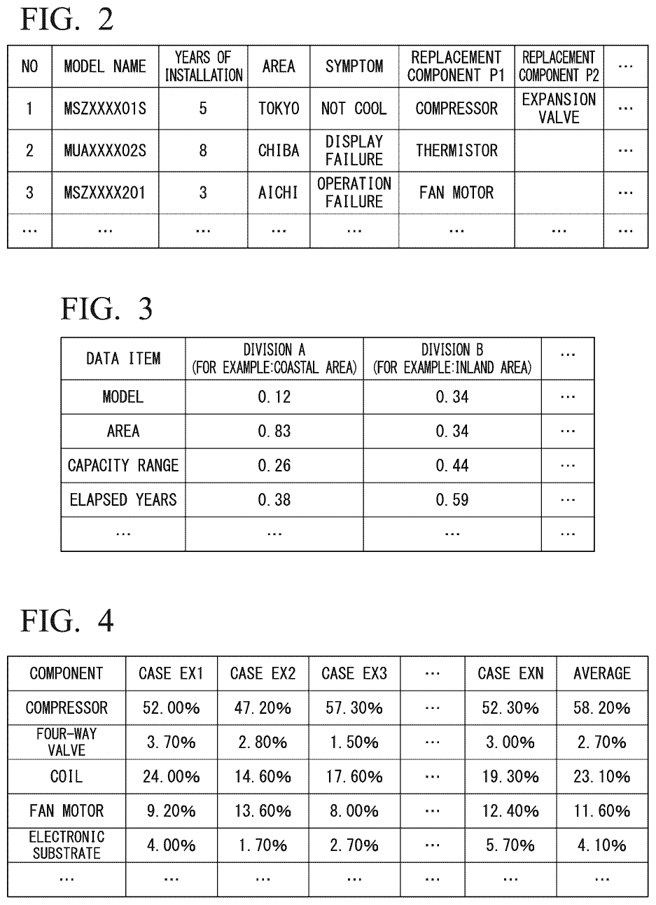

The maintenance record information storage unit 421 stores maintenance record information collected from a plurality of maintenance terminals 31. The maintenance record information is, for example, a maintenance work report created by the maintenance service provider. The maintenance record information storage unit 421 stores, for example, maintenance record information obtained by diagnosing the diagnostic target device 21 in the past, which includes data of a plurality of data items and defective component information. Here, an example of data in the maintenance record information storage unit 421 will be described with reference to FIG. 2.

FIG. 2 is a diagram showing an example of the data in the maintenance record information storage unit 421 in the present embodiment.

As shown in FIG. 2, the maintenance record information storage unit 421 stores maintenance record information in which a number (NO), a model name, years of installation, an area, a symptom, a replacement component P1, and a replacement component P2 are associated with each other.

In FIG. 2, the NO is an example of individual identification information of the diagnostic target device 21 (20). In addition, the model name indicates the model name of the diagnostic target device 21 (20). Further, the model name is an example of device identification information for identifying the diagnostic target device 21 (20). Furthermore, the years of installation and the area indicate the number of years (period) and the area where the diagnostic target device 21 (20) is installed. In addition, the symptom indicates a symptom of a malfunction or a failure when the diagnostic target device 21 (20) was diagnosed in the past. Further, the replacement component P1 and the replacement component P2 indicate components that were replaced in the past maintenance work. Furthermore, the model name, the years of installation, the area, and the symptom correspond to data items.

For example, in the example shown in FIG. 2, the maintenance record information corresponding to NO “1” indicates that the model name is “MSZXXX01S” and the years of installation are “5” (5 years). In addition, the maintenance record information indicates that the area is “Tokyo” and the symptom is “not cold”. Further, the maintenance record information indicates that the replacement component P1 is a “compressor” and the replacement component P2 is an “expansion valve”.

Returning to the description of FIG. 1, the operation data storage unit 422 stores the operation data collected from each diagnostic target device 21 (20). Here, the operation data is detection data of various sensors (not shown) included in each diagnostic target device 21 (20), error code information, and the like. The operation data storage unit 422 stores, for example, the above-described NO and model name and the operation data in association with each other.

The weight storage unit 423 (an example of an importance degree storage unit) divides the maintenance record information stored in the maintenance record information storage unit 421 according to a division condition predetermined based on the data item and stores a learning result obtained by learning a relationship between the data item and the defective component in the maintenance record information for each division. In addition, the learning result indicates a weight (degree of importance) of the data item for each division condition. Here, an example of data in the weight storage unit 423 will be described with reference to FIG. 3.

FIG. 3 is a diagram showing an example of the data in the weight storage unit 423 in the present embodiment.

As shown in FIG. 3, the weight storage unit 423 stores the data items and the weights in association with each other for each division. The data items include, for example, a model, an area, a capacity range, elapsed years, and the like.

In the example shown in FIG. 3, the area of the data item is divided into a division A of a coastal area and a division B of an inland area. The division condition here is that the area of the data item is either the coastal area or the inland area.

In the division A (coastal area), the weight of the model is “0.12”, the weight of the area is “0.83”, the weight of the capacity range is “0.26”, and the weight of the elapsed years is “0.38”. In addition, in the division B (inland area), the weight of the model is “0.34”, the weight of the area is “0.34”, the weight of the capacity range is “0.44”, and the weight of the elapsed years is “0.59”.

In addition, the larger the value of each weight, the larger the degree of importance. The smaller the value of each weight, the smaller the degree of importance.

Returning to the description of FIG. 1, the model storage unit 424 stores the defective component detection model which is a result of learning using the maintenance record information and the operation data as learning data. The defective component detection model is, for example, an estimation model that estimates a defective component from a similar case of the malfunction (failure) of the diagnostic target device 22 (20).

The learning processing unit 43 is, for example, a functional unit that is implemented by causing a processor including a CPU to execute a program. The learning processing unit 43 executes a learning process of learning the weight of the data item for each division and learning the defective component detection model.

The learning processing unit 43 includes a maintenance record information collection unit 431, an operation data collection unit 432, a weight learning unit 433, and a model learning unit 434.

The maintenance record information collection unit 431 collects the maintenance record information from the maintenance terminal 31 (30) and stores the collected maintenance record information in the maintenance record information storage unit 421. The maintenance record information collected by the maintenance record information collection unit 431 is used as learning data for learning the weight of the data item and the defective component detection model.

The operation data collection unit 432 collects the operation data from the diagnostic target device 21 (20) and stores the collected operation data in the operation data storage unit 422. The operation data collected by the operation data collection unit 432 may be used as a portion of the learning data for learning the weight of the data item and the defective component detection model.

The weight learning unit 433 (an example of an importance degree learning unit) divides the maintenance record information stored in the maintenance record information storage unit 421 according to a division condition predetermined based on the data item, learns the relationship between the data item and the defective component in the maintenance record information for each division, and generates the weight (degree of importance) of the data item for each division condition. The weight learning unit 433 generates the weight of the data item for each division condition with a machine learning method, such as LightGBM, that calculates the degree of importance of each piece of item data, using the past maintenance record information stored in the maintenance record information storage unit 421 and the operation data stored in the operation data storage unit 422 as the learning data. In addition, the weight learning unit 433 may generate the weight of the data item for each division condition, using the maintenance record information as the learning data, without using the operation data.

The division condition is, for example, whether the data item of the area shown in FIG. 3 is the coastal area or the inland area. In this case, the weight learning unit 433 generates the weight of each data item in the coastal area (division A) and the weight of each data item in the inland area (division B).

That is, the weight learning unit 433 divides the learning data according to whether the area in which the diagnostic target device 21 (20) is installed is the coastal area (division A) or the inland area (division B) and executes the learning process on each learning data item to generate the weight of each data item.

Further, the maintenance service provider determines in advance the division condition, such as the data item of the area, that has a large influence on the defective component (replacement component) in consideration of the maintenance record information and the operation data.

The weight learning unit 433 stores the generated weight of the data item for each division condition in the weight storage unit 423. In addition, the weight learning unit 433 transmits, for example, the weight of the data item for each division condition stored in the weight storage unit 423 to the diagnostic device 10 via the NW communication unit 41.

The model learning unit 434 learns the maintenance record information as the learning data and generates the defective component detection model that estimates a defective component from similar cases. For example, the model learning unit 434 generates the defective component detection model with a machine learning method, such as LightGBM or a support vector machine (SVM), using the past maintenance record information stored in the maintenance record information storage unit 421 and the operation data stored in the operation data storage unit 422 as the learning data. In addition, the model learning unit 434 may generate the defective component detection model, using the maintenance record information as the learning data, without using the operation data.

The model learning unit 434 stores the generated defective component detection model in the model storage unit 424. In addition, the model learning unit 434 transmits, for example, the defective component detection model stored in the model storage unit 424 to the diagnostic device 10 via the NW communication unit 41.

The diagnostic device 10 is, for example, a server device that can be connected to the network NW1. The diagnostic device 10 estimates a defective component, using the defective component detection model generated by the model learning device 40 and the weight (degree of importance) for each data item. The diagnostic device 10 estimates the defective component of the diagnostic target device 22, using the diagnostic data and the operation data acquired from the maintenance terminal 32 via the network NW1 as input data. In addition, the diagnostic device 10 generates a display screen as the output information, based on the estimation result of the defective component, and transmits the display screen to the maintenance terminal 32 via the network NW1.

Further, the diagnostic device 10 includes an NW communication unit 11, a device storage unit 12, and a diagnostic processing unit 13.

The NW communication unit 11 is a functional unit that is implemented by a communication device such as a network adapter. The NW communication unit 11 is connected to the network NW1 and can communicate with the maintenance terminal 32 and the model learning device 40.

The device storage unit 12 is, for example, a storage device, such as a RAM, a flash memory, or an HDD, and stores various types of information used by the diagnostic device 10. The device storage unit 12 includes a diagnostic data storage unit 121, an operation data storage unit 122, a weight storage unit 123, a model storage unit 124, a similar case storage unit 125, an estimation result storage unit 126, and an output information storage unit 127.

The diagnostic data storage unit 121 stores the diagnostic data acquired from the maintenance terminal 32. The diagnostic data has the same data items as the input data excluding the items of the replacement components in the maintenance record information used by the model learning device 40 in the learning process. The diagnostic data storage unit 121 stores, for example, diagnostic data of the data items such as the model, the area, the capacity range, and the elapsed years.

The operation data storage unit 122 stores the operation data of the diagnostic target device 22 acquired from the maintenance terminal 32. The operation data has the same data items as the operation data used by the model learning device 40 in the learning process. The operation data has, for example, data items such as detection data (indoor temperature, indoor humidity, outdoor temperature, outdoor humidity, and the like) of various sensors and an error code.

The weight storage unit 123 stores the weight of the data item for each division condition acquired from the model learning device 40. The weight storage unit 123 stores, for example, the same information as the weight storage unit 423 shown in FIG. 3.

The model storage unit 124 stores the defective component detection model acquired from the model learning device 40. The model storage unit 124 stores the same information as the model storage unit 424 of the model learning device 40.

The similar case storage unit 125 stores information of the past similar cases extracted by a similar case extraction unit 133 which will be described below. The similar case storage unit 125 stores a plurality of similar cases (for example, about 100 similar cases) extracted using the weight of the data item acquired from the model learning device 40.

The estimation result storage unit 126 stores candidates for the defective components of the diagnostic target device 22 estimated by a defective component estimation unit 134 which will be described below. The estimation result storage unit 126 stores information, in which the candidates for the defective components estimated by the defective component estimation unit 134 and failure probabilities (likelihoods) thereof are associated with each other, and an average value of the failure probabilities in all of the similar cases as the estimation result estimated using the defective component detection model for each similar case. Here, an example of data in the estimation result storage unit 126 will be described with reference to FIG. 4.

FIG. 4 is a diagram showing an example of the data in the estimation result storage unit 126 in the present embodiment.

As shown in FIG. 4, the estimation result storage unit 126 stores the candidates for the defective components and the failure probabilities in association with each other for each similar case. Further, the estimation result storage unit 126 further stores the average value of the failure probabilities in all of the similar cases.

For example, in the example shown in FIG. 4, in a case EX1 among the similar cases, the candidates for the defective components are a compressor, a four-way valve, a coil, a fan motor, and an electronic substrate, and the failure probabilities thereof are “52.00%”, “3.70%”, “24.00%”, “9.20%”, and “4.00%”. In addition, the average failure probabilities in the cases EX1 to EXN among the similar cases are “58.20%”, “2.70%”, “23.10%”, “11.60%”, and “4.10%”.

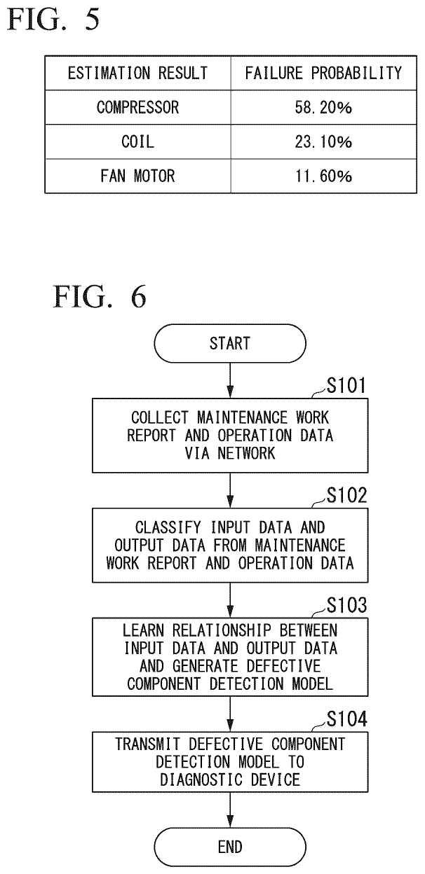

Further, returning to the description of FIG. 1, the output information storage unit 127 stores output information from an output information generation unit 135 which will be described below. The output information storage unit 127 stores, for example, output information based on the estimation result shown in FIG. 5.

FIG. 5 is a diagram showing an example of data in the output information storage unit 127 in the present embodiment.

As shown in FIG. 5, the output information storage unit 127 stores display screen information in which the estimation result and the failure probability are associated with each other. Here, the estimation result shows the top three components with the highest failure probabilities among the candidates for the defective components.

For example, in the example shown in FIG. 5, the components having the highest average failure probabilities in the cases EX1 to EXN among the similar cases stored in the estimation result storage unit 126 are the “compressor”, the “coil”, and the “fan motor”, and the failure probabilities thereof are “50.20%”, “23.10%”, and “11.60%”.

Further, returning to the description of FIG. 1, the diagnostic processing unit 13 is, for example, a functional unit that is implemented by causing a processor including a CPU to execute a program. The diagnostic processing unit 13 includes a diagnostic data acquisition unit 131, an operation data acquisition unit 132, the similar case extraction unit 133, the defective component estimation unit 134, and the output information generation unit 135.

The diagnostic data acquisition unit 131 acquires the diagnostic data from the maintenance terminal 32 via the NW communication unit 11. The diagnostic data acquisition unit 131 stores the acquired diagnostic data in the diagnostic data storage unit 121.

The operation data acquisition unit 132 acquires the operation data of the diagnostic target device 22 from the maintenance terminal 32 via the NW communication unit 11. The operation data acquisition unit 132 stores the acquired operation data of the diagnostic target device 22 in the operation data storage unit 122.

The similar case extraction unit 133 classifies diagnostic data for diagnosing the diagnostic target device 22 to be diagnosed according to a predetermined division condition and extracts similar cases that are similar to the diagnostic data from the maintenance record information storage unit 421 of the model learning device 40 based on the weight of the data item corresponding to the classification (division condition).

The similar case extraction unit 133 classifies whether the acquired diagnostic data and operation data correspond to, for example, the coastal area or the inland area, according to the area in which the diagnostic target device 22 is installed. For example, in the coastal area, there is a strong tendency for failures to occur due to metal rust, and the weight (degree of importance) of the data item for failure diagnosis is different. Therefore, it is considered that it is effective to classify the data into the above-mentioned divisions (the coastal area or the inland area).

The similar case extraction unit 133 acquires the weight of each data item corresponding to the classification (division condition) from the weight storage unit 123 and calculates the degree of similarity with the past case stored in the maintenance record information storage unit 421, using the weight of each data item corresponding to the classification (division condition). The similar case extraction unit 133 calculates the degree of similarity (Simₙ) using, for example, the following Equation (1).

$${Sim}_{n} = α * {f}_{x} ( \overline{x} - x 〉 + β * {f}_{y} ( \overline{y} - y ) + … \qquad ( 1 )$$

Here, Sim, indicates the degree of similarity with an n-th past case, and α, β, and . . . indicate the weight of each data item. In addition, x~, y~, . . . indicate diagnostic data of the input value of each data item, and x, y, . . . indicate diagnostic data of the past case of each data item. Further, the function f is a function that outputs “1” when the past case and the data of the input item are matched with each other and outputs “0” when the past case and the data of the input item are not matched with each other.

Furthermore, in the present embodiment, a variable with a horizontal line above the letter “x” is represented by x~, and a variable with a horizontal line above the letter “y” is represented by y~.

The similar case extraction unit 133 multiplies the degree of match of each data item (“1” is used when the data item is matched and “0” is used when the data item is not matched) by the weight (α, β) of each data item to calculate the sum of the degrees of match of all of the data items as the degree of similarity (Simₙ) with the n-th past case, using the above-described Equation (1).

The similar case extraction unit 133 extracts, for example, 100 cases as the similar cases in descending order of the calculated degree of similarity (Sim). As described above, the similar case extraction unit 133 extracts a plurality of similar cases. The similar case extraction unit 133 stores the extracted similar cases in the similar case storage unit 125.

The defective component estimation unit 134 estimates a defective component of the diagnostic target device 22 based on the similar cases extracted by the similar case extraction unit 133. The defective component estimation unit 134 estimates the defective component from the similar cases, using the defective component detection model stored in the model storage unit 124. For example, the defective component estimation unit 134 estimates candidates for the defective components and failure probabilities for each of the plurality of similar cases (for example, 100 cases) stored in the similar case storage unit 125, using the defective component detection model, as shown in FIG. 4.

In addition, the defective component estimation unit 134 stores the estimation results (the candidates for the defective components and the failure probabilities) in the estimation result storage unit 126.

The output information generation unit 135 generates output information based on the estimation results of the defective component estimation unit 134. The output information generation unit 135 calculates the average value of the failure probabilities for the defective components in the plurality of similar cases stored in the estimation result storage unit 126. For example, as shown in FIG. 4, the output information generation unit 135 stores the calculated average value of the failure probabilities in the estimation result storage unit 126.

In addition, the output information generation unit 135 selects a specific number of (for example, three) candidates for the defective components in descending order of the average value of the failure probabilities and generates output information including the selected candidates for the defective components. The output information generation unit 135 generates, for example, output information (display screen) shown in FIG. 5 and stores the output information in the output information storage unit 127.

The output information generation unit 135 transmits the generated output information to the maintenance terminal 32 via the NW communication unit 11. As described above, the output information generation unit 135 generates the output information including the selected candidates for the defective components and the average value of the failure probabilities and transmits the generated output information to the maintenance terminal 32.

Next, an operation of the maintenance assistance system 1 according to the present embodiment will be described with reference to the drawings.

First, a model learning process of the model learning device 40 will be described with reference to FIG. 6.

FIG. 6 is a flowchart showing an example of the model learning process of the model learning device 40 in the present embodiment.

As shown in FIG. 6, the model learning device 40 collects the maintenance work report and the operation data via the network NW1 (Step S101). The maintenance record information collection unit 431 of the model learning device 40 collects the maintenance work report as the maintenance record information from the maintenance terminal 31 via the NW communication unit 41 and stores the collected maintenance record information (maintenance work report) in the maintenance record information storage unit 421.

In addition, the operation data collection unit 432 of the model learning device 40 collects the operation data from the diagnostic target device 21 via the NW communication unit 41 and stores the collected operation data in the operation data storage unit 422.

Then, the model learning unit 434 of the model learning device 40 classifies the input data and the output data from the maintenance work report and the operation data (Step S102). The model learning unit 434 classifies the maintenance record information (maintenance work report) stored in the maintenance record information storage unit 421 and the operation data stored in the operation data storage unit 422 as the learning data into the input data and the output data. For example, in the case shown in FIG. 2, the “model name”, the “years of installation”, the “area”, and the “symptom” are classified as the input data, and the “replacement component P1” and the “replacement component P2” are classified as the output data.

Then, the model learning unit 434 learns the relationship between the input data and the output data and generates the defective component detection model (Step S103). The model learning unit 434 generates the defective component detection model from the above-described learning data, using a machine learning method such as LightGBM or SVM. The model learning unit 434 stores the generated defective component detection model in the model storage unit 424.

Then, the model learning unit 434 transmits the defective component detection model to the diagnostic device 10 (Step S104). The model learning unit 434 transmits the defective component detection model stored in the model storage unit 424 to the diagnostic device 10 via the NW communication unit 41. In addition, the transmitted defective component detection model is stored in the model storage unit 124 of the diagnostic device 10. After the process in Step S104, the model learning unit 434 ends the model learning process.

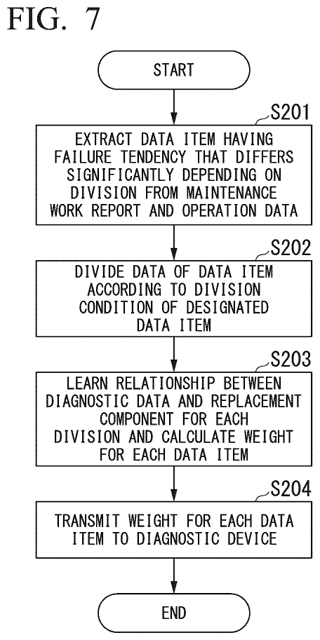

Next, a weight learning process of the model learning device 40 will be described with reference to FIG. 7.

FIG. 7 is a flowchart showing an example of the weight learning process of the model learning device 40 in the present embodiment.

As shown in FIG. 7, first, the model learning device 40 extracts a data item having a failure tendency that differs significantly depending on the division from the maintenance work report and the operation data (Step S201), The weight learning unit 433 of the model learning device 40 extracts, for example, the “area” as the data item having a significantly different failure tendency.

Then, the weight learning unit 433 divides the data of the data item according to the division condition of the designated data item (Step S202). The weight learning unit 433 divides the above-described learning data into, for example, the coastal area and the inland area according to the “area” of the designated data item.

Then, the weight learning unit 433 learns the relationship between the diagnostic data and the replacement component for each division and calculates the weight for each data item (Step S203). For example, the weight learning unit 433 calculates the weight of each data item in the coastal area from the diagnostic data (learning data) whose division condition is the coastal area, using the machine learning method such as LightGBM. In addition, for example, the weight learning unit 433 calculates the weight of each data item in the inland area from the diagnostic data (learning data) whose division condition is the inland area, using the machine learning method such as LightGBM. The weight learning unit 433 stores the calculated weight of each data item for each division condition in the weight storage unit 423, for example, as shown in FIG. 3.

Then, the weight learning unit 433 transmits the weight of each data item to the diagnostic device 10 (Step S204). The weight learning unit 433 transmits the weight of each data item for each division condition stored in the weight storage unit 423 to the diagnostic device 10 via the NW communication unit 41. In addition, the transmitted weight of each data item for each division condition is stored in the weight storage unit 123 of the diagnostic device 10. After the process in Step S204, the weight learning unit 433 ends the weight learning process.

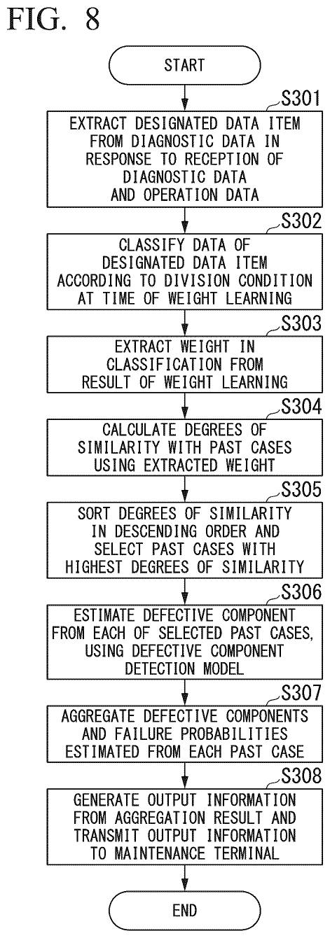

Next, a diagnosis process of the diagnostic device 10 will be described with reference to FIG. 8.

FIG. 8 is a flowchart showing an example of the diagnosis process of the diagnostic device 10 in the present embodiment.

As shown in FIG. 8, first, the diagnostic device 10 extracts the designated data item from the diagnostic data in response to the reception of the diagnostic data and the operation data (Step S301). The diagnostic data acquisition unit 131 of the diagnostic device 10 acquires the diagnostic data from the maintenance terminal 32 via the NW communication unit 11, and the operation data acquisition unit 132 acquires the operation data of the diagnostic target device 22 from the maintenance terminal 32 via the NW communication unit 11. The similar case extraction unit 133 of the diagnostic device 10 extracts the designated data item (for example, the “area”) in response to the acquisition (reception) of the diagnostic data and the operation data.

Then, the similar case extraction unit 133 classifies the data of the designated data item according to the division condition at the time of weight learning (Step S302). The similar case extraction unit 133 classifies the diagnostic data and the operation data into, for example, the coastal area or the inland area.

Then, the similar case extraction unit 133 extracts the weight in the classification from the result of the weight learning (Step S303). The similar case extraction unit 133 extracts the weight of each data item corresponding to the classification (division condition) classified according to the diagnostic data and the operation data from the weight storage unit 123. For example, when the classification is the coastal area, the similar case extraction unit 133 acquires the weight of each data item corresponding to the coastal area from the weight storage unit 123. In addition, for example, when the classification is the inland area, the similar case extraction unit 133 acquires the weight of each data item corresponding to the inland area from the weight storage unit 123.

Then, the similar case extraction unit 133 calculates the degree of similarity with the past case, using the extracted weight (Step S304). The similar case extraction unit 133 calculates the degree of similarity (Simₙ) between the past case stored in the maintenance record information storage unit 421, and the diagnostic data and the operation data, using the above-described Equation (1).

Then, the similar case extraction unit 133 sorts the degrees of similarity in descending order and selects the past cases (for example, 100 cases) with the highest degrees of similarity (Step S305). The similar case extraction unit 133 stores the selected past cases (for example, 100 cases) having the highest degrees of similarity as the similar cases in the similar case storage unit 125.

Then, the defective component estimation unit 134 of the diagnostic device 10 estimates a defective component from each selected past case using the defective component detection model (Step S306), The defective component estimation unit 134 estimates candidates for the defective components and the failure probabilities for each of the similar cases stored in the similar case storage unit 125, using the defective component detection model stored in the model storage unit 124. The defective component estimation unit 134 stores the estimation results in the estimation result storage unit 126, for example, as in the cases EX1 to EXN shown in FIG. 4.

Then, the output information generation unit 135 of the diagnostic device 10 aggregates the defective components and the failure probabilities estimated from each past case (Step S307). The output information generation unit 135 calculates the average value of the failure probabilities for the defective components in a plurality of past cases (similar cases). For example, as shown in FIG. 4, the output information generation unit 135 calculates the average value of the failure probabilities for each defective component and stores the average value in the estimation result storage unit 126.

Then, the output information generation unit 135 generates output information from the aggregation result and transmits the output information to the maintenance terminal 32 (Step S308). The output information generation unit 135 sorts the average values of the failure probabilities for each defective component in descending order and determines candidates for the top three defective components with the highest average values of the failure probabilities. The output information generation unit 135 generates, for example, the output information shown in FIG. 5, using the top three candidates for the defective components having the highest average values of the failure probabilities. The output information generation unit 135 stores the generated output information in the output information storage unit 127 and transmits the output information to the maintenance terminal 32 via the NW communication unit 11. After the process in Step S308, the output information generation unit 135 ends the diagnosis process of the diagnostic device 10.

As described above, the maintenance assistance system 1 according to the present embodiment includes the maintenance record information storage unit 421, the weight learning unit 433 (importance degree learning unit), the similar case extraction unit 133, and the defective component estimation unit 134. The maintenance record information storage unit 421 stores the maintenance record information obtained by diagnosing the diagnostic target device 21 in the past, which includes data of a plurality of data items and defective component information. The weight learning unit 433 (importance degree learning unit) divides the maintenance record information stored in the maintenance record information storage unit 421 according to a predetermined division condition (for example, the coastal area or the inland area), based on the data item, learns the relationship between the data item and the defective component in the maintenance record information for each division, and generates the weight (degree of importance) of the data item for each division condition. The similar case extraction unit 133 classifies the diagnostic data for diagnosing the diagnostic target device 22 to be diagnosed according to the division condition and extracts the similar cases similar to the diagnostic data from the maintenance record information storage unit 421 based on the degree of importance of the data item corresponding to the classification (division condition). The defective component estimation unit 134 estimates a defective component of the diagnostic target device 22 based on the similar cases extracted by the similar case extraction unit 133.

Therefore, the maintenance assistance system 1 according to the present embodiment extracts the similar cases, using the weight (degree of importance) of the data item for each division condition which has been divided (classified) by the predetermined division condition (for example, the coastal area or the inland area). As a result, it is possible to extract appropriate similar cases with higher accuracy. Therefore, the maintenance assistance system 1 according to the present embodiment can improve the accuracy of failure diagnosis and can improve the quality of diagnosis by the maintenance service provider.

In addition, the maintenance assistance system 1 according to the present embodiment can extract appropriate similar cases, for example, in consideration of the difference in failure tendency for each data item, such as regionality, and can select candidates for replacement components in consideration of the regionality.

Further, the maintenance assistance system 1 according to the present embodiment includes the model learning unit 434. The model learning unit 434 learns the maintenance record information as the learning data and generates the defective component detection model that estimates a defective component from the similar cases. The defective component estimation unit 134 estimates a defective component from the similar cases using the defective component detection model.

Therefore, the maintenance assistance system 1 according to the present embodiment estimates a defective component from the similar cases, using the defective component detection model. As a result, it is possible to more appropriately estimate the defective component and to improve the quality of diagnosis by the maintenance service provider.

In addition, the maintenance assistance system 1 according to the present embodiment includes the output information generation unit 135. The output information generation unit 135 generates the output information based on the estimation results of the defective component estimation unit 134. The similar case extraction unit 133 extracts a plurality of similar cases. The defective component estimation unit 134 estimates the defective component and the failure probability for each of the plurality of similar cases, using the defective component detection model. The output information generation unit 135 calculates the average value of the failure probabilities for the defective components in the plurality of similar cases, selects a specific number of (for example, the top three) candidates for the defective components in descending order of the average value of the failure probabilities and generates the output information including the selected candidates for the defective components.

Therefore, the maintenance assistance system 1 according to the present embodiment selects candidates for the defective components using the average value of the failure probabilities for the defective components in the plurality of similar cases. Therefore, it is possible to estimate the candidates for the defective components with higher accuracy. In addition, the maintenance assistance system 1 according to the present embodiment outputs a specific number of (for example, the top three) candidates for the defective components in descending order of the average value of the failure probabilities. Therefore, it is possible to provide the maintenance service provider with criteria for determining the defective components and to improve the quality of diagnosis.

Further, in the present embodiment, the similar case extraction unit 133 extracts the similar cases that are similar to the diagnostic data received from the maintenance terminal. The output information generation unit 135 generates the output information including the selected candidates for the defective components and the average value of the failure probabilities and transmits the generated output information to the maintenance terminal 32.

Therefore, the maintenance assistance system 1 according to the present embodiment transmits the output information including the selected candidates for the defective components and the average value of the failure probabilities to the maintenance terminal 32. As a result, it is possible to provide the maintenance service provider with the criteria for determining the defective components.

In addition, in the present embodiment, the weight learning unit 433 generates the weight (degree of importance) of the data item for each division condition, using the learning data including the operation data (for example, the detection data of the sensor, the error code, and the like) of the diagnostic target device 21 collected from the diagnostic target device 21 in the past and the maintenance record information. The model learning unit 434 generates the defective component detection model using the learning data including both the operation data of the diagnostic target device 21 and the maintenance record information.

Therefore, the maintenance assistance system 1 according to the present embodiment generates the defective component detection model and the weight (degree of importance) of the data item for each division condition in consideration of the operation data (for example, the detection data of the sensor, the error code, and the like). Therefore, it is possible to more accurately estimate the defective component.

Further, in the present embodiment, the weight learning unit 433 divides the maintenance record information according to the area in which the diagnostic target device 21 is installed. The similar case extraction unit 133 classifies the diagnostic data by area and extracts the similar cases based on the weight (degree of importance) of the data item corresponding to the classified area.

Therefore, the maintenance assistance system 1 according to the present embodiment can extract appropriate similar cases in consideration of the difference in regional failure tendency and can appropriately select candidates for the replacement components in consideration of the regionality.

In addition, the maintenance assistance method according to the present embodiment is a maintenance assistance method for the maintenance assistance system 1 including the maintenance record information storage unit 421 and includes a weight learning step, a similar case extraction step, and a defective component estimation step.

The maintenance record information storage unit 421 stores the maintenance record information obtained by diagnosing the diagnostic target device 21 in the past, which includes data of a plurality of data items and defective component information. In the weight learning step, the weight learning unit 433 divides the maintenance record information stored in the maintenance record information storage unit 421 according to a division condition predetermined based on the data item, learns the relationship between the data item and the defective component in the maintenance record information for each division, and generates the weight (degree of importance) of the data item for each division condition. In the similar case extraction step, the similar case extraction unit 133 classifies the diagnostic data for diagnosing the diagnostic target device 22 to be diagnosed, according to the division condition, and extracts the similar cases that are similar to the diagnostic data from the maintenance record information storage unit 421 based on the weight of the data item corresponding to the classification (division condition). In the defective component estimation step, the defective component estimation unit 134 estimates the defective component of the diagnostic target device 22 based on the similar cases extracted by the similar case extraction unit 133.

Therefore, the maintenance assistance method according to the present embodiment has the same effect as the maintenance assistance system 1 described above, can extract appropriate similar cases with higher accuracy, and can improve the quality of diagnosis.

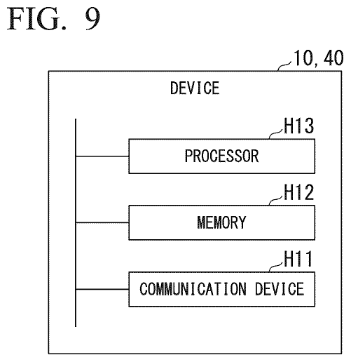

FIG. 9 is a diagram showing a hardware configuration of the diagnostic device 10 and the model learning device 40 of the maintenance assistance system 1 according to the present embodiment.

A device shown in FIG. 9 shows a hardware configuration of each device (the diagnostic device 10 and the model learning device 40) of the maintenance assistance system 1.

As shown in FIG. 9, each device (the diagnostic device 10 and the model learning device 40) of the maintenance assistance system 1 includes a communication device H11, a memory H12, and a processor H13.

The communication device H11 is, for example, a communication device that can be connected to the network NW1 such as a LAN card.

The memory H12 is, for example, a storage device, such as a RAM, a flash memory, or an HDD, and stores various types of information and programs used by each device (the diagnostic device 10 and the model learning device 40).

The processor H13 is, for example, a processing circuit including a CPU and the like. The processor H13 executes the program stored in the memory H12 to execute various processes of each device (the diagnostic device 10 and the model learning device 40).

In addition, the present disclosure is not limited to the above-described embodiment and can be modified without departing from the gist of the present disclosure.

For example, in the above-described embodiment, the example has been described in which the weight division condition is divided into the coastal area and the inland area according to the “area” of the data item. However, the present disclosure is not limited thereto, and other data items and division conditions may be used. For example, when the “years of installation” is used as the data item, the data may be divided (classified) under a division condition of 5 years or more and less than 5 years.

In addition, in the above-described embodiment, the example has been described in which the maintenance assistance system 1 includes the diagnostic device 10 and the model learning device 40. However, the present disclosure is not limited thereto. The diagnostic device 10 may include the functions of the model learning device 40, and the maintenance assistance system 1 may be implemented by one device.

Further, in the above-described embodiment, the model learning device 40 may include some of the functions of the diagnostic device 10, or the diagnostic device 10 may include some of the functions of the model learning device 40. Furthermore, the diagnostic device 10 and the model learning device 40 may be implemented by three or more devices.

Moreover, in the above-described embodiment, the example has been described in which the similar case extraction unit 133 extracts a specific number of similar cases (for example, 100 cases). However, the present disclosure is not limited thereto, and one past case having the maximum degree of similarity may be extracted as the similar case.

In addition, in the above-described embodiment, the example has been described in which the model learning device 40 generates the weight of each data item and the defective component detection model, using the maintenance record information and the operation data. However, the present disclosure is not limited thereto, and the model learning device 40 may generate the weight of each data item and the defective component detection model, without using the operation data. Further, in this case, the diagnostic device 10 extracts the similar cases from the diagnostic data without using the operation data.

In addition, in the above-described embodiment, the example has been described in which the communication of each device is implemented using two networks of the network NW1 and the network NW2. However, the present disclosure is not limited thereto, and the communication may be implemented using one network or three or more networks.

Furthermore, in the above-described embodiment, the example has been described in which the diagnostic target device 20 is an air conditioner. However, the present disclosure is not limited thereto. The diagnostic target device 20 may be, for example, another home appliance, an IoT device, or the like.

In addition, each component of the maintenance assistance system 1 includes a computer system therein. Then, a program for implementing the functions of each component provided in the maintenance assistance system 1 may be recorded on a computer-readable recording medium. Then, the program recorded on the recording medium may be loaded into a computer system and executed to perform the processes in each component provided in the maintenance assistance system 1. Here, the “program recorded on the recording medium is loaded into the computer system and executed” includes installing the program in the computer system. Here, the “computer system” mentioned here includes an OS and hardware such as a peripheral device.

In addition, the “computer system” may include a plurality of computer devices that are connected via a network including a communication line such as the Internet, a WAN, a LAN, or a dedicated line. In addition, the “computer-readable recording medium” means a storage device, for example, a portable medium, such as a flexible disk, a magneto-optical disk, a ROM, or a CD-ROM, or a hard disk provided in the computer system. As described above, the recording medium storing the program may be a non-transitory recording medium such as a CD-ROM.

Furthermore, the recording medium also includes an internal or external recording medium that is accessible by a distribution server for distributing the program. In addition, the program may be divided into a plurality of parts, and the plurality of parts may be downloaded at different timings and then combined in each component provided in the maintenance assistance system 1. Alternatively, the divided programs may be distributed by different distribution servers. Furthermore, the “computer-readable recording medium” also includes a medium that holds the program for a certain period of time such as a volatile memory (RAM) in a server or client computer system when the program is transmitted via the network. Moreover, the above-described program may be a program for implementing some of the above-mentioned functions. Furthermore, the program may be a so-called difference file (difference program) that can implement the above-described functions in combination with a program that has already been recorded on the computer system.

### REFERENCE SIGNS LIST

1 Maintenance assistance system
10 Diagnostic device
11, 41, 321 NW communication unit
12 Device storage unit
13 Diagnostic processing unit
20, 21, 22 Diagnostic target device
30, 31, 32 Maintenance terminal
40 Model learning device
42 Learning storage unit
43 Learning processing unit
121 Diagnostic data storage unit
122, 422 Operation data storage unit
123, 423 Weight storage unit
124, 424 Model storage unit
125 Similar case storage unit
126 Estimation result storage unit
127 Output information storage unit
131 Diagnostic data acquisition unit
132 Operation data acquisition unit
133 Similar case extraction unit
134 Defective component estimation unit
135 Output information generation unit
322 Input unit
323 Display unit
324 Terminal storage unit
325 Terminal control unit
421 Maintenance record information storage unit
431 Maintenance record information collection unit
432 Operation data collection unit
433 Weight learning unit
434 Model learning unit
NW1, NW2 Network

1. A maintenance assistance system comprising:
maintenance record information storage circuitry configured to store maintenance record information obtained by diagnosing a diagnostic target device in a past, the maintenance record information including data of a plurality of data items and defective component information;
importance degree learning circuitry configured to divide the maintenance record information stored in the maintenance record information storage circuitry according to a division condition predetermined based on the data item, to learn a relationship between the data item and a defective component in the maintenance record information for each division, and to generate a degree of importance of the data item for each division condition;
similar case extraction circuitry configured to classify diagnostic data for diagnosing the diagnostic target device to be diagnosed according to the division condition and to extract a similar case similar to the diagnostic data from the maintenance record information storage circuitry based on a degree of importance of the data item corresponding to the classification; and
defective component estimation circuitry configured to estimate a defective component of the diagnostic target device based on the similar case extracted by the similar case extraction circuitry.

2. The maintenance assistance system according to claim 1, further comprising:
model learning circuitry configured to learn the maintenance record information as learning data and to generate a defective component detection model that estimates the defective component from the similar case,
wherein the defective component estimation circuitry estimates the defective component from the similar case, using the defective component detection model.

3. The maintenance assistance system according to claim 2, further comprising:
output information generation circuitry configured to generate output information based on an estimation result estimated by the defective component estimation circuitry,
wherein the similar case extraction circuitry extracts a plurality of the similar cases,
the defective component estimation circuitry estimates the defective component and a failure probability for each of the plurality of the similar cases, using the defective component detection model, and
the output information generation circuitry calculates an average value of the failure probabilities for the defective components in the plurality of the similar cases, selects a specific number of candidates for the defective components in descending order of the average value of the failure probabilities, and generates the output information including the selected candidates for the defective components.

4. The maintenance assistance system according to claim 3,
wherein the similar case extraction circuitry extracts the similar case similar to the diagnostic data received from a maintenance terminal, and
the output information generation circuitry generates the output information including the selected candidates for the defective components and the average value of the failure probabilities and transmits the generated output information to the maintenance terminal.

5. The maintenance assistance system according to claim 2,
wherein the importance degree learning circuitry generates the degree of importance of the data item for each division condition, using the learning data including both operation data of the diagnostic target device collected from the diagnostic target device in the past and the maintenance record information, and
the model learning circuitry generates the defective component detection model, using the learning data including both the operation data of the diagnostic target device and the maintenance record information.

6. The maintenance assistance system according to claim 1,
wherein the importance degree learning circuitry divides the maintenance record information according to an area in which the diagnostic target device is installed and generates the degree of importance of the data item for each area, and
the similar case extraction circuitry classifies the diagnostic data according to the area and extracts the similar case based on the degree of importance of the data item corresponding to the classified area.

7. A maintenance assistance method for a maintenance assistance system including maintenance record information storage circuitry configured to store maintenance record information obtained by diagnosing a diagnostic target device in a past, the maintenance record information including data of a plurality of data items and defective component information, the maintenance assistance method comprising:
causing importance degree learning circuitry to divide the maintenance record information stored in the maintenance record information storage circuitry according to a division condition predetermined based on the data item, to learn a relationship between the data item and a defective component in the maintenance record information for each division, and to generate a degree of importance of the data item for each division condition;
causing similar case extraction circuitry to classify diagnostic data for diagnosing the diagnostic target device to be diagnosed according to the division condition and to extract a similar case similar to the diagnostic data from the maintenance record information storage circuitry based on a degree of importance of the data item corresponding to the classification; and
causing defective component estimation circuitry to estimate a defective component of the diagnostic target device based on the similar case extracted by the similar case extraction circuitry.
